(19) United States
(12) Patent Application Publication
(10) Pub. No.: US 2013/0249148 A1
(43) Pub. Date: Sep. 26, 2013

(54) SHAPE ADJUSTING MECHANISM FOR EXTRUSION MOLDING MACHINE, AND METHOD OF MANUFACTURING CYLINDRICAL MEMBER

(71) Applicants: Tomoo MATSUSHIMA, Kanagawa (JP); Kenji OOMORI, Kanagawa (JP); Shoichi MORITA, Kanagawa (JP)

(72) Inventors: Tomoo MATSUSHIMA, Kanagawa (JP); Kenji OOMORI, Kanagawa (JP); Shoichi MORITA, Kanagawa (JP)

(73) Assignee: FUJI XEROX CO., LTD., Tokyo (JP)

(21) Appl. No.: 13/605,113

(22) Filed: Sep. 6, 2012

(30) Foreign Application Priority Data
Mar. 21, 2012 (JP) 2012-064560

(51) Int. Cl. B29C 47/20; B29D 22/00

(52) U.S. Cl. 264/573; 425/326.1

(57) ABSTRACT

A shape adjusting mechanism for an extrusion molding machine includes a shape adjusting member, a blow-in mechanism, and a discharge mechanism. The shape adjusting member comes into contact with an inner circumferential surface of a molten substantially cylindrical resin extruded and transported from a ferrule provided to an extrusion molding machine, and adjusts the shape of the substantially cylindrical resin. The blow-in mechanism blows a gas into the substantially cylindrical resin transported between the ferrule and the shape adjusting member. The discharge mechanism discharges to the outside the gas in the substantially cylindrical resin transported between the ferrule and the shape adjusting member.

### CROSS-REFERENCE TO RELATED APPLICATIONS

This application is based on and claims priority under 35 USC 119 from Japanese Patent Application No. 2012-064560 filed Mar. 21, 2012.

### BACKGROUND

### Technical Field

The present invention relates to a shape adjusting mechanism for an extrusion molding machine, and to a method of manufacturing a cylindrical member.

### SUMMARY

According to an aspect of the invention, there is provided a shape adjusting mechanism for an extrusion molding machine. The shape adjusting mechanism includes a shape adjusting member, a blow-in mechanism, and a discharge mechanism. The shape adjusting member comes into contact with an inner circumferential surface of a molten substantially cylindrical resin extruded and transported from a ferrule provided to an extrusion molding machine, and adjusts the shape of the substantially cylindrical resin. The blow-in mechanism blows a gas into the substantially cylindrical resin transported between the ferrule and the shape adjusting member. The discharge mechanism discharges to the outside the gas in the substantially cylindrical resin transported between the ferrule and the shape adjusting member.

### BRIEF DESCRIPTION OF THE DRAWINGS

Exemplary embodiments of the present invention will be described in detail based on the following figures, wherein:

FIG. 1 is a cross-sectional view illustrating a sizing mechanism according to a first exemplary embodiment of the invention;

FIG. 2 is a perspective view illustrating a sizing die used in the sizing mechanism according to the first exemplary embodiment of the invention;

FIG. 3 is a schematic configuration diagram illustrating an extrusion molding machine including the sizing mechanism according to the first exemplary embodiment of the invention;

FIG. 4 is a diagram illustrating evaluation results evaluating cylindrical members molded by the use of the sizing mechanism according to the first exemplary embodiment of the invention;

FIG. 5 is a cross-sectional view illustrating a sizing mechanism according to a second exemplary embodiment of the invention;

FIGS. 6A and 6B are perspective views illustrating a sizing die used in a sizing mechanism according to a third exemplary embodiment of the invention;

FIG. 7 is a cross-sectional view illustrating a sizing die used in a sizing mechanism according to a fourth exemplary embodiment of the invention;

FIGS. 8A, 8B, and 8C are cross-sectional views illustrating the sizing die used in the sizing mechanism according to the fourth exemplary embodiment of the invention;

FIG. 9 is a perspective view illustrating a sizing mechanism according to a fifth exemplary embodiment of the invention;

FIG. 10 is a cross-sectional view illustrating the sizing mechanism according to the fifth exemplary embodiment of the invention; and

FIGS. 11A, 11B, and 11C are plan views illustrating the movement of shutter members and so forth used in the sizing mechanism according to the fifth exemplary embodiment of the invention.

### DETAILED DESCRIPTION

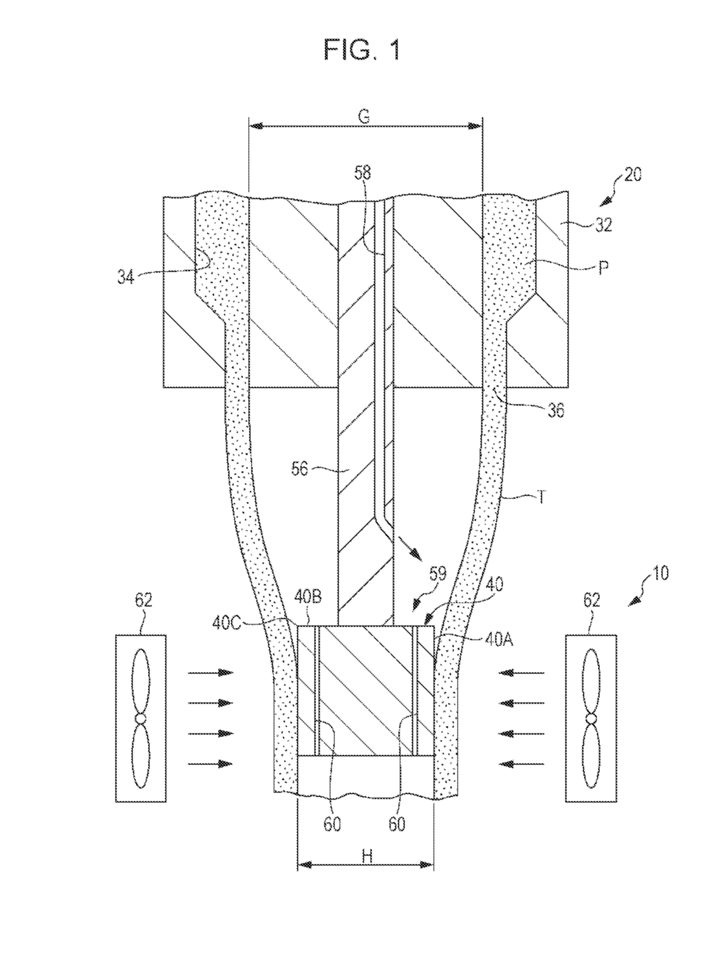

In accordance with FIGS. 1 to 4, description will be made of an example of a shape adjusting mechanism for an extrusion molding machine and a method of manufacturing a cylindrical member according to a first exemplary embodiment of the present invention. An arrow UP illustrated in the drawings indicates an upward vertical direction.

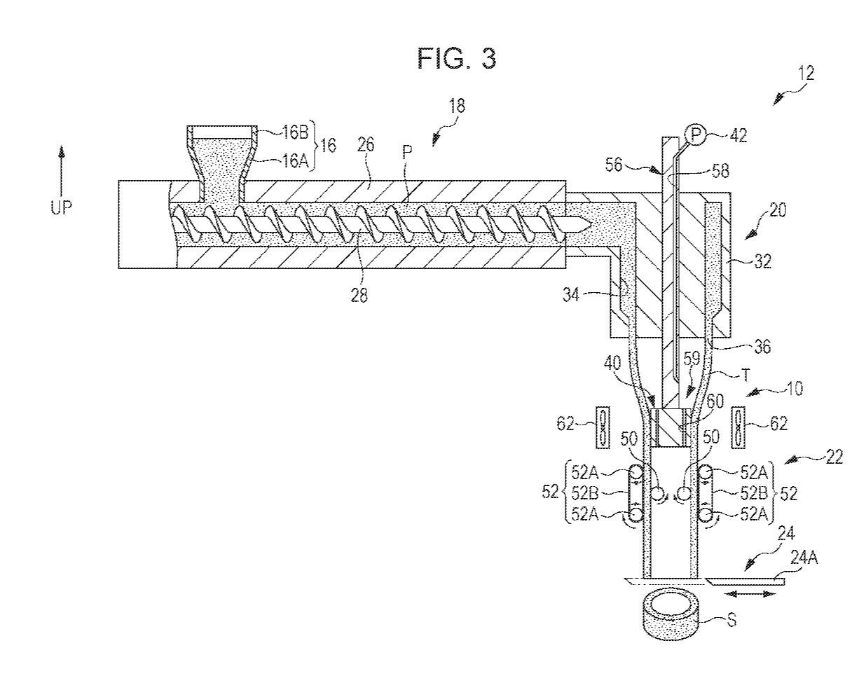

Overall Configuration: FIG. 3 illustrates an extrusion molding machine 12 including a sizing mechanism 10 as an example of a shape adjusting mechanism for an extrusion molding machine according to the present exemplary embodiment. As illustrated in FIG. 3, the extrusion molding machine 12 includes, as major mechanisms, a hopper 16, an extruder 18, a ferrule 20, the sizing mechanism 10, a transport mechanism 22, and a cutting mechanism 24. A pelletized resin material P is put into the hopper 16. The extruder 18 transports the resin material P put into the hopper 16, while melting and stirring the resin material P. The ferrule 20 extrudes the resin material P molten and stirred by the extruder 18 into a cylindrical resin T. The sizing mechanism 10 stabilizes (adjusts) the shape of the molten cylindrical resin T extruded from the ferrule 20, as compared with a case where a later-described air pump 42 is not provided. The transport mechanism 22 applies transporting force to the cylindrical resin T to transport the cylindrical resin T from the ferrule 20 toward the sizing mechanism 10. The cutting mechanism 24 cuts the cylindrical resin T stabilized in shape by the sizing mechanism 10 into a determined length, and thereby forms a cylindrical member S.

Hopper: As illustrated in FIG. 3, the hopper 16 includes a conical portion 16A increased in diameter toward the upper side and a cylindrical portion 16B connected to the upper end of the conical portion 16A. The cylindrical portion 16B has an upper portion which is exposed to the outside, and into which the pelletized resin material P is put.

Extruder: The extruder 18 includes a cylindrical barrel 26 which extends in a horizontal direction, a screw 28 which is provided inside the barrel 26 and rotates to transport the resin material P put into the hopper 16 while stirring the resin material P, and a not-illustrated heating device which heats the barrel 26.

Specifically, a base end portion of the hopper 16 is connected to one end portion of the barrel 26 such that the pelletized resin material P put into the hopper 16 is transported into the barrel 26. Further, the screw 28 is disposed inside the barrel 26 to extend from the one end portion of the barrel 26 toward the other end portion of the barrel 26. The screw 28 rotates to cause the resin material P transported into the barrel 26 to be transported from the one end portion of the barrel 26 toward the other end portion of the barrel 26, while stirring the resin material P.

With this configuration, the resin material P transported into the barrel 26 heated by the heating device is molten, and is transported from the one end portion of the barrel 26 toward the other end portion of the barrel 26 by the rotating screw 28, while being stirred by the screw 28.

Ferrule: The ferrule 20 for molding the resin material P into the cylindrical resin T is connected to the other end portion of the barrel 26. A ferrule body 32 of the ferrule 20 is formed with a resin flow channel 34, into which the molten resin material P extruded from the other end portion of the barrel 26 by the rotating screw 28 flows.

Further, a downstream end of the resin flow channel 34 in a flow direction of the resin material P is provided with an extrusion port 36 for extruding the resin material P to the outside from the ferrule body 32. The extrusion port 36 is formed into a ring shape such that the resin material P extruded from the extrusion port 36 is formed into the molten cylindrical resin T.

Sizing Mechanism: The sizing mechanism 10 for stabilizing the shape of the molten cylindrical resin T extruded from the ferrule 20 includes a sizing die 40 (an example of a shape adjusting member), an air pump 42, and through-holes 60. The sizing die 40 comes into contact with an inner circumferential surface of the molten cylindrical resin T extruded from the extrusion port 36. The air pump 42 is an example of a blow-in mechanism which blows air (an example of a gas) into the cylindrical resin T transported between the ferrule 20 and the sizing die 40. The through-holes 60 configure a ventilation mechanism 59 which discharges to the outside the air in the cylindrical resin T transported between the ferrule 20 and the sizing die 40. The sizing mechanism 10 will be described in detail later.

Transport Mechanism: The transport mechanism 22 for applying the transporting force to the cylindrical resin T to transport the cylindrical resin T from the ferrule 20 toward the sizing mechanism 10 is disposed on the opposite side of the ferrule 20 across the sizing die 40. The transport mechanism 22 includes plural (two in the exemplary embodiment) rollers 50 and belt devices 52. The rollers 50 are provided inside the cylindrical resin T, and come into contact with the inner circumferential surface of the cylindrical resin T. Each of the belt devices 52 is provided on the opposite side of the corresponding roller 50 across a cylinder wall of the cylindrical resin T, and comes into contact with an outer circumferential surface of the cylindrical resin T.

Each of the belt devices 52 includes a pair of rollers 52A aligned in a transport direction of the cylindrical resin T and an endless belt 52B wound around the pair of rollers 52A. Each of the belt devices 52 further includes a not-illustrated motor which applies to the rollers 50 and 52A rotational force acting in the directions of arrows in the drawing. In accordance with the rotation of the rollers 52A, the endless belt 52B circularly moves in the direction of an arrow in the drawing.

With this configuration, the cylindrical resin T sandwiched by the rotating rollers 50 and the circularly moving endless belts 52B is applied with the transporting force.

Cutting Mechanism: On the downstream side of the transport mechanism 22 in the transport direction of the cylindrical resin T, the cutting mechanism 24 is provided which cuts the cylindrical resin T stabilized in shape by the sizing mechanism 10 into the determined length.

Specifically, the cutting mechanism 24 is provided with a cutter 24A which cuts the cylindrical resin T. The cutter 24A is operated with determined timing. Thereby, the cylindrical resin T is cut into the determined length to be formed into the cylindrical member S.

Configuration of Major Components: Subsequently, the sizing mechanism 10 will be described.

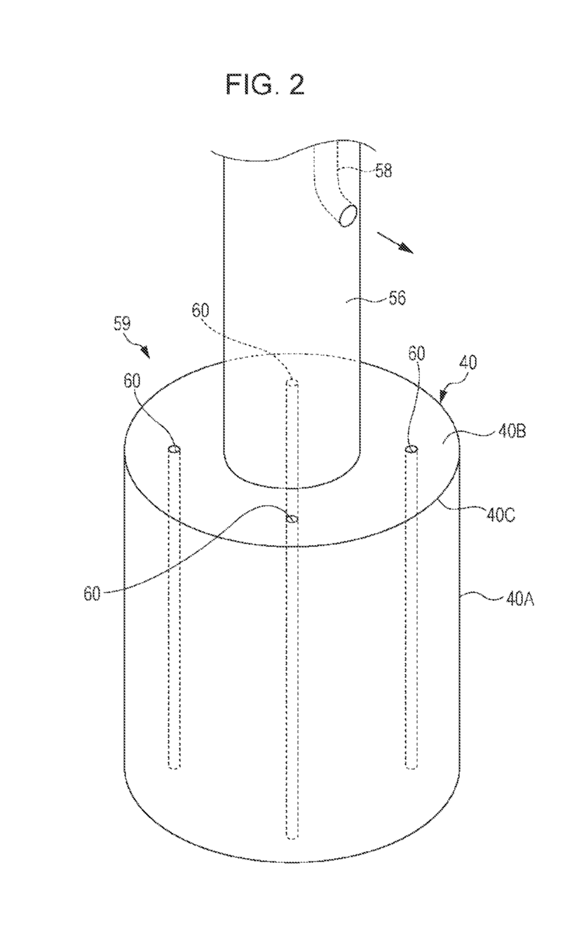

As illustrated in FIGS. 1 and 2, a cylindrical support member 56 extending in a vertical direction has a lower end portion fixed to an upper surface 40B of the sizing die 40, and the sizing die 40 is supported by the support member 56. The support member 56 extending in the vertical direction passes through the ferrule body 32, and an upper end portion of the support member 56 is exposed to the outside from the ferrule body 32 (see FIG. 3). A portion of the support member 56 passing through the ferrule body 32 is fixed to the ferrule body 32. Further, the support member 56 is formed with a communication hole 58 which extends in the vertical direction and allows the outside of the support member 56 passing through the ferrule body 32 and the interior of the cylindrical resin T transported between the ferrule 20 and the sizing die 40 to communicate with each other.

As illustrated in FIG. 3, the air pump 42 for blowing air into the cylindrical resin T transported between the ferrule 20 and the sizing die 40 is connected to an upper end portion of the communication hole 58.

As illustrated in FIGS. 1 and 2, the sizing die 40 fixed to the lower end portion of the support member 56 extends in the transport direction of the cylindrical resin T (vertical direction in the exemplary embodiment), and is formed into a cylindrical shape larger in diameter than the support member 56. The inner circumferential surface of the cylindrical resin T extruded from the extrusion port 36 (see FIG. 3) comes into contact with an outer circumferential surface 40A of the cylindrically shaped sizing die 40.

Specifically, the air pump 42 blows air into the cylindrical resin T transported between the ferrule 20 and the sizing die 40. Thereby, the pressure in the cylindrical resin T is increased to be higher than the atmospheric pressure, and the cylindrical resin T expands outward in a bent manner. With the cylindrical resin T expanding outward, the inner circumferential surface of the cylindrical resin T comes into contact with the outer circumferential surface 40A of the sizing die 40 without touching a corner portion 40C of the sizing die 40.

Further, the through-holes 60, which discharge the air in the cylindrical resin T transported between the ferrule 20 and the sizing die 40 to the outside exposed to the atmosphere, are provided to pass through the sizing die 40 in the transport direction of the cylindrical resin T. Accordingly, the air in the cylindrical resin T transported between the ferrule 20 and the sizing die 40 is discharged to the outside through the through-holes 60. Therefore, the leakage of air to the outside from between the sizing die 40 and the cylindrical resin T is suppressed.

Further, plural fans 62 are provided which blow wind to the cylindrical resin T in contact with the outer circumferential surface 40A of the sizing die 40, to thereby cool the cylindrical resin T.

Operations: Subsequently, operations of the extrusion molding machine 12 and the sizing mechanism 10 will be described with explanation of a method of manufacturing the cylindrical member S.

Method of Manufacturing Cylindrical Member: As illustrated in FIG. 3, in the extrusion molding machine 12, the pelletized resin material P put into the hopper 16 is transported into the barrel 26 provided to the extruder 18. The resin material P transported into the barrel 26 heated by the heating device is molten, and is transported from the one end portion of the barrel 26 toward the other end portion of the barrel 26 by the rotating screw 28, while being stirred by the screw 28 (stirring and transporting process).

The resin material P extruded from the other end portion of the barrel 26 by the rotating screw 28 flows into the resin flow channel 34 formed in the ferrule body 32, and is further extruded into the cylindrical resin T from the extrusion port 36 (extrusion process).

The inner circumferential surface of the molten cylindrical resin T extruded from the ferrule 20 comes into contact with the outer circumferential surface 40A (see FIG. 1) of the sizing die 40 provided to the sizing mechanism 10. Further, the fans 62 blow wind to the cylindrical resin T in contact with the outer circumferential surface 40A of the sizing die 40, and thereby cool the cylindrical resin T. Thereby, the shape of the cylindrical resin T is stabilized (stabilization process).

Further, the cutter 24A provided to the cutting mechanism 24 cuts the cylindrical resin T stabilized in shape in the stabilization process into the determined length, and thereby forms the cylindrical member S (cutting process).

Herein, in the stabilization process, the air pump 42 blows air into the cylindrical resin T transported between the ferrule 20 and the sizing die 40. Thereby, the pressure in the cylindrical resin T is increased to be higher than the atmospheric pressure, and the cylindrical resin T expands outward in a bent manner. Thereby, the inner circumferential surface of the cylindrical resin T comes into contact with the outer circumferential surface 40A of the sizing die 40 without touching the corner portion 40C of the sizing die 40 (see FIG. 1).

Further, the air in the cylindrical resin T transported between the ferrule 20 and the sizing die 40 is discharged to the outside through the through-holes 60 provided in the sizing die 40. Therefore, the discharge (leakage) of air to the outside from between the sizing die 40 and the cylindrical resin T is suppressed.

Further, the through-holes 60 are provided in the sizing die 40, which configures an internal space of the cylindrical resin T transported between the ferrule 20 and the sizing die 40. Accordingly, the air in the cylindrical resin T is discharged to the outside with a simple configuration, as compared with a case where the sizing die 40 is not provided with a through-hole.

With this configuration, cockling of the cylindrical resin T (cylindrical member S) caused by the discharge of air to the outside from between the sizing die 40 and the cylindrical resin T is suppressed.

Evaluations: Herein, cylindrical members S molded by the use of the sizing mechanism 10 according to the exemplary embodiment and a cylindrical member S molded by the use of a sizing mechanism according to a comparative example are evaluated in terms of the cockling (undulation) and so forth.

The pelletized resin material P used in the evaluations is obtained by the following method.

Resin Material: A semi-aromatic polyamide resin (N1000C-H32 manufactured by Kuraray Co., Ltd., which is a condensate of terephthalic acid as an aromatic dicarboxylic acid compound and 1,9-nonanediamine/2-methyl-1,8-octanediamine as an aliphatic diamine compound, wherein an aromatic ring of the aromatic dicarboxylic acid compound is a benzene ring, and the number of carbons in the alkyl group of the aliphatic diamine compound is 9) is mixed with 22 phr of a carbon black (Monarch M880 manufactured by Cabot Specialty Chemicals, Inc. and having a primary particle diameter of 15 nm). With the use of a twin-screw melt mixer (manufactured by Parker Corporation), the resin and the carbon black are melt-mixed with rotational torque of the screws set to 121 Nm, and with a barrel heating temperature set in phases to be 270° C. at the most downstream position (on the material supply side) of the barrel and be gradually increased therefrom to a maximum heating temperature of 300° C. Further, a molten strand (a rope shape having a diameter of approximately 2 mm) of the mixture discharged from a discharge port of the mixer is passed through a water tank to be cooled. Then, the cooled and solidified strand is inserted into a pelletizer and cut. Thereby, a pelletized resin material P (mixed resin pellets) having a length of approximately 5 mm is obtained. A unit “phr” represents the mass of the material relative to the mass of the resin represented as 100.

First Example: The above-described pelletized resin material P is put into the hopper 16. With the temperature of the barrel 26 set to 280° C., and with the temperature of the ferrule body 32, which has a diameter of 170 mm for extruding the resin (size G illustrated in FIG. 1), set to 300° C., the resin material P is extruded into the cylindrical resin T from the ferrule body 32, while the cylindrical resin T is being applied with the transporting force by the transport mechanism 22.

The inner circumferential surface of the extruded cylindrical resin T is brought into contact with the outer circumferential surface 40A of the sizing die 40 formed with the through-holes 60 and having a diameter of 160 mm (size H illustrated in FIG. 1), and thereby the cylindrical resin T is cooled. The cooled cylindrical resin T is cut with the use of the cutting mechanism 24, and thereby a cylindrical member S (endless belt) having a diameter of 159.7 mm and a width (height) of 232 mm is obtained.

The sizing die 40 is formed with four through-holes 60 each having a diameter of 0.7 mm.

Second Example: Compared with the first example, the diameter of the ferrule body 32 for extruding therefrom the resin (size G illustrated in FIG. 1) is set to 140 mm. In the other aspects, the second example is configured similarly to the first example. Thereby, a cylindrical member S (endless belt) having a diameter of 159.5 mm and a width (height) of 232 mm is obtained.

Comparative Example: Compared with the first example, a sizing die not formed with a through-hole is used. In the other aspects, the comparative example is configured similarly to the first example. Thereby, a cylindrical member S (endless belt) having a diameter of 159.6 mm and a width (height) of 232 mm is obtained.

Evaluation Items: As to cockling (undulation) evaluation, the measurement of surface cockling (undulation) is performed on the respective cylindrical members S (endless belts) obtained in the first example, the second example, and the comparative example with the use of a surface roughness measuring apparatus SURFCOM 1400D (manufactured by Tokyo Seimitsu Co., Ltd.). The evaluation criterion is set such that cockling of 3.0 μm or less is at an acceptable quality level. As to image evaluation, each of the cylindrical members S (endless belts) obtained in the first example, the second example, and the comparative example is used as a transfer belt of an image forming apparatus (DPC105 manufactured by Fuji Xerox Co., Ltd.). Then, an image obtained after operating the image forming apparatus and outputting fifty halftone (magenta 30%) images is evaluated. An image not having an image failure, such as the appearance of a streak, is evaluated as favorable, and any other image is evaluated as unfavorable.

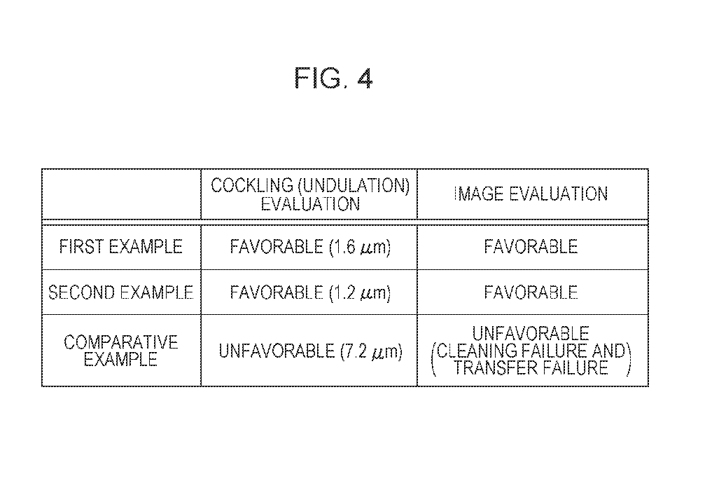

Evaluation Results: FIG. 4 illustrates the results of the cockling (undulation) evaluation and the image evaluation summarized in a table. As illustrated in FIG. 4, in the first and second examples, a favorable result is obtained in both the cockling (undulation) evaluation and the image evaluation. Meanwhile, in the comparative example, a satisfactory result fails to be obtained in both the cockling (undulation) evaluation and the image evaluation. Particularly as to the image evaluation, the cockling of the cylindrical member S causes a cleaning failure to clean the cylindrical member S and a transfer failure to transfer a toner image formed on the cylindrical member S to an object to which the toner image is to be transferred. As a result, the image failure is caused.

As understood from the above-described results, the air in the cylindrical resin T transported between the ferrule 20 and the sizing die 40 is discharged through the through-holes 60 provided in the sizing die 40, and thereby the cockling occurring in the cylindrical member S molded by extrusion molding is suppressed.

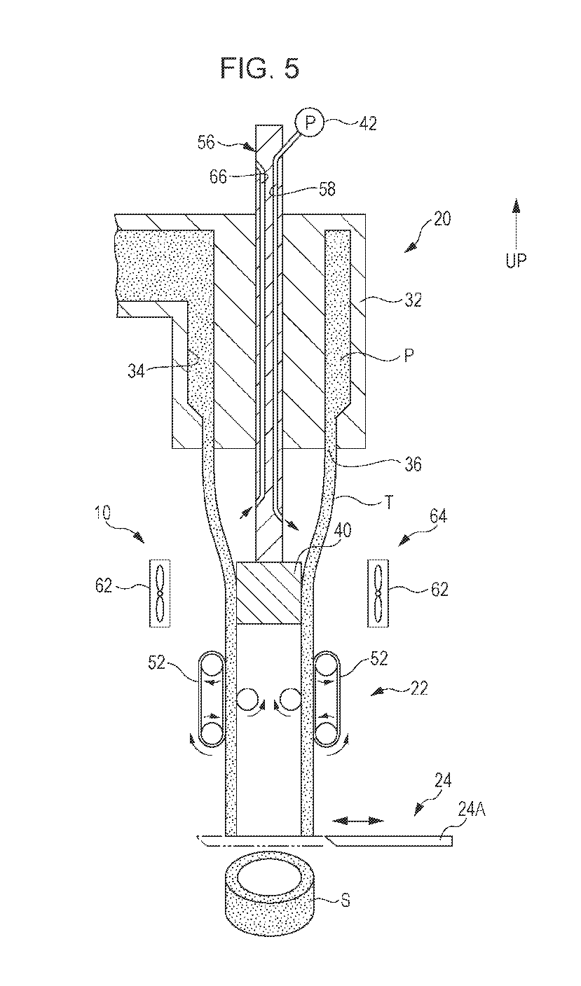

Second Exemplary Embodiment: Subsequently, an example of a sizing mechanism 64 according to a second exemplary embodiment of the invention will be described in accordance with FIG. 5. The same members as those of the first exemplary embodiment will be designated by the same reference numerals, and description thereof will be omitted.

As illustrated in FIG. 5, the sizing die 40 is not provided with a through-hole for discharging to the outside the air in the cylindrical resin T transported between the ferrule 20 and the sizing die 40. In the second exemplary embodiment, such a through-hole is replaced by a through-hole 66 formed in the support member 56 as an example of a discharge mechanism which discharges to the outside the air in the cylindrical resin T transported between the ferrule 20 and the sizing die 40.

Accordingly, the air in the cylindrical resin T transported between the ferrule 20 and the sizing die 40 is discharged to the outside through the through-hole 66 formed in the support member 56. The second exemplary embodiment is similar to the first exemplary embodiment in the other operations.

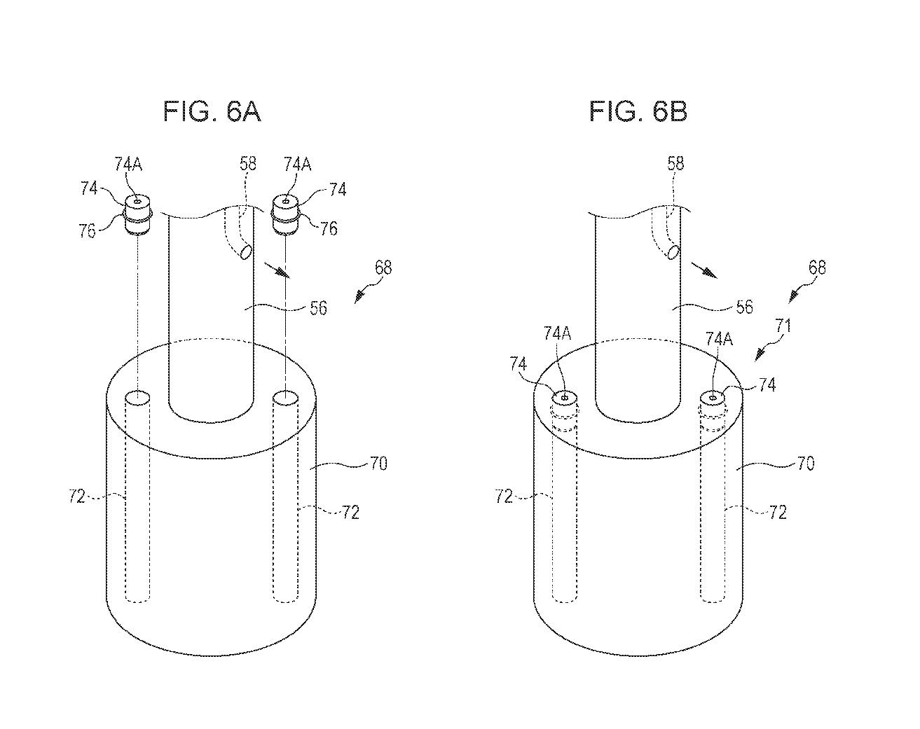

Third Exemplary Embodiment: Subsequently, an example of a sizing mechanism 68 according to a third exemplary embodiment of the invention will be described in accordance with FIGS. 6A and 6B. The same members as those of the first exemplary embodiment will be designated by the same reference numerals, and description thereof will be omitted.

As illustrated in FIGS. 6A and 6B, a sizing die 70 of the sizing mechanism 68 according to the third exemplary embodiment is formed with two through-holes 72. Further, small-diameter members 74 are provided to be attachable to and detachable from the respective through-holes 72. Each of the small-diameter members 74 is an example of a changing unit that changes the flow rate of the air passing through the corresponding through-hole 72.

Specifically, the small-diameter member 74 is formed into a cylindrical shape capable of being housed in the through-hole 72, and an outer circumferential surface of the small-diameter member 74 is attached with an 0-ring 76 which suppresses the leakage of air between the outer circumferential surface of the small-diameter member 74 and the inner circumferential surface of the through-hole 72. Further, the small-diameter member 74 is formed with a through-hole 74A which is smaller in diameter than the through-hole 72, and which discharges to the outside the air in the cylindrical resin T transported between the ferrule 20 and the sizing die 70. Accordingly, a ventilation mechanism 71, which discharges the air in the cylindrical resin T to the outside, includes the through-holes 72 and the small-diameter members 74.

Accordingly, if it is desired to change the flow rate of the air passing through the through-holes 72, the small-diameter members 74 may be attached to the through-holes 72, or the small-diameter members 74 may be detached from the through-holes 72 attached with the small-diameter members 74, to thereby change the flow rate of the air passing through the through-holes 72.

Further, the through-holes 74A formed in the respective small-diameter members 74 may be changed in diameter, to thereby change the flow rate of the air passing through the through-holes 72. The third exemplary embodiment is similar to the first exemplary embodiment in the other operations.

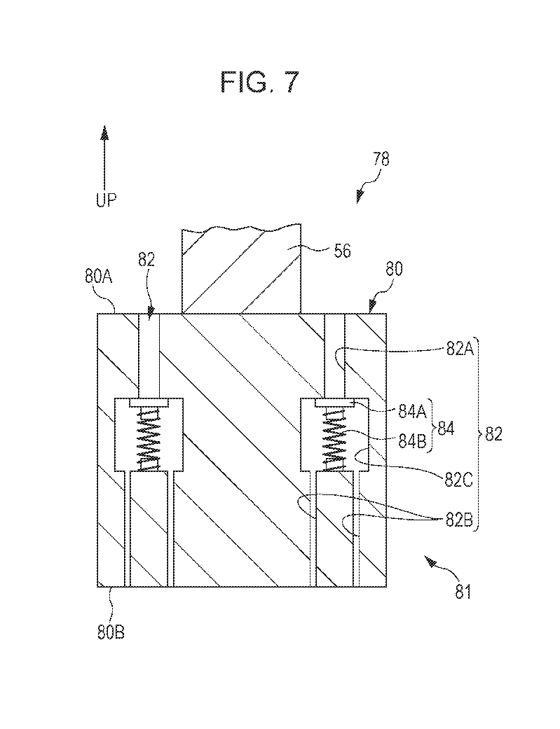

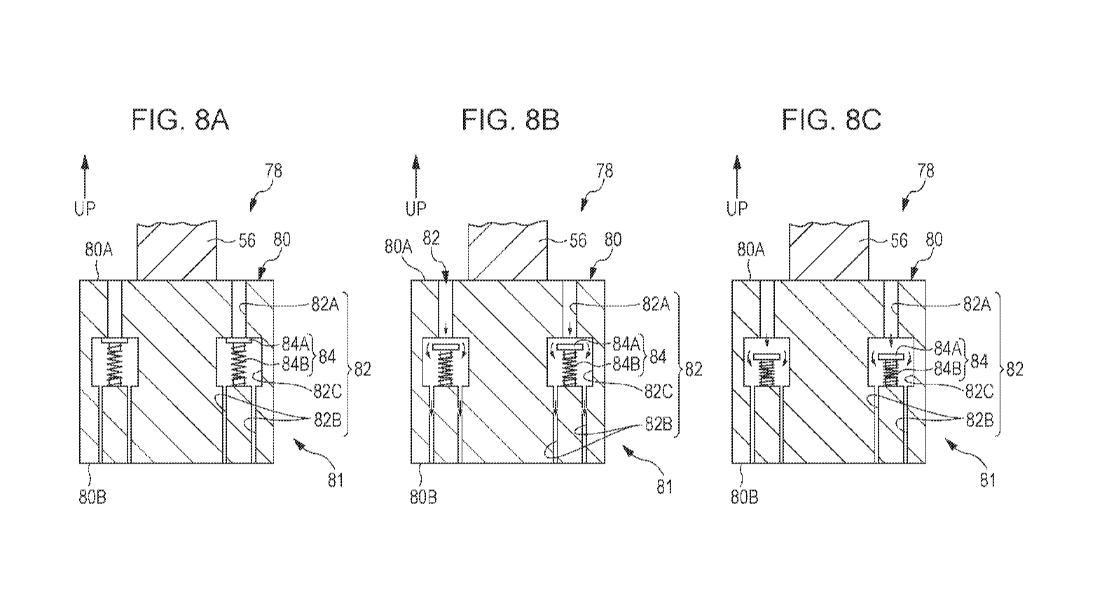

Fourth Exemplary Embodiment: Subsequently, an example of a sizing mechanism 78 according to a fourth exemplary embodiment of the invention will be described in accordance with FIGS. 7 to 8C. The same members as those of the first exemplary embodiment will be designated by the same reference numerals, and description thereof will be omitted.

As illustrated in FIG. 7, a sizing die 80 of the sizing mechanism 78 according to the fourth exemplary embodiment is formed with two through-holes 82, and is provided with changing devices 84, each of which is an example of a changing unit that changes the flow rate of the air passing through the corresponding through-hole 82.

Specifically, each of the through-holes 82 includes an upper communication path 82A opening in an upper surface 80A of the sizing die 80, two lower communication paths 82B opening in a lower surface 80B of the sizing die 80, and a communication chamber 82C which allows the upper communication path 82A and the lower communication paths 82B to communicate with each other.

Each of the changing devices 84 is disposed in the corresponding communication chamber 82C. The changing device 84 includes an opening and closing valve 84A and a spring member 84B. The opening and closing valve 84A is movably provided to change the flow rate of the air passing between the upper communication path 82A and the communication chamber 82C (to change flow channel resistance). The spring member 84B is an example of an elastically deformable member which supports the opening and closing valve 84A, and which is elastically deformed by the air pressure in the cylindrical resin T received by the opening and closing valve 84A and thereby moves the opening and closing valve 84A. The spring member 84B biases the opening and closing valve 84A such that the opening and closing valve 84A closes the upper communication path 82A. Accordingly, a ventilation mechanism 81, which discharges the air in the cylindrical resin T to the outside, includes the through-holes 82 and the changing devices 84.

With this configuration, as illustrated in FIG. 8A, if the air pressure in the cylindrical resin T transported between the ferrule 20 and the sizing die 80 is equal to or lower than the atmospheric pressure, the opening and closing valves 84A close the upper communication paths 82A with the biasing force of the spring members 84B.

Further, as illustrated in FIG. 8B, if the air pressure in the cylindrical resin T is higher than the atmospheric pressure, the air pressure is transmitted to the spring members 84B via the opening and closing valves 84A, and the spring members 84B are deformed (contracted). Thereby, the opening and closing valves 84A separate from and open the upper communication paths 82A.

Further, as illustrated in FIG. 8C, if the air pressure in the cylindrical resin T is further increased, the spring members 84B are further deformed (further contracted). Thereby, the opening and closing valves 84A further separate from and widely open the upper communication paths 82A.

As described above, if the air pressure in the cylindrical resin T is high, the degree of opening (opening degree) of the upper communication paths 82A opened by the opening and closing valves 84A is greater than in a case where the air pressure in the cylindrical resin T is low. Accordingly, the air in the cylindrical resin T is effectively discharged to the outside.

Further, if the air pressure in the cylindrical resin T is equal to or lower than the atmospheric pressure, the opening and closing valves 84A close the upper communication paths 82A with the biasing force of the spring members 84B. In this case, therefore, the air pressure in the cylindrical resin T is maintained. The fourth exemplary embodiment is similar to the first exemplary embodiment in the other operations.

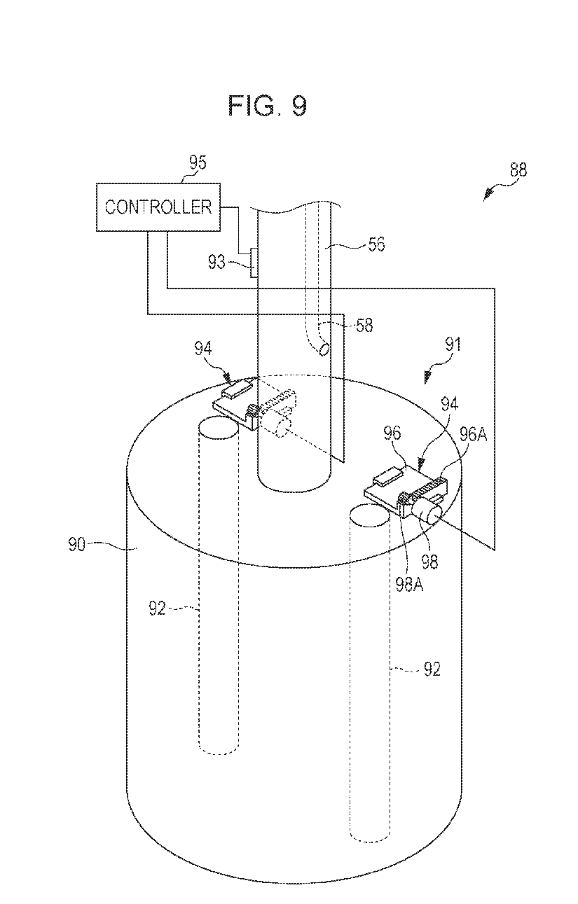

Fifth Exemplary Embodiment: Subsequently, an example of a sizing mechanism 88 according to a fifth exemplary embodiment of the invention will be described in accordance with FIGS. 9 to 11C. The same members as those of the first exemplary embodiment will be designated by the same reference numerals, and description thereof will be omitted.

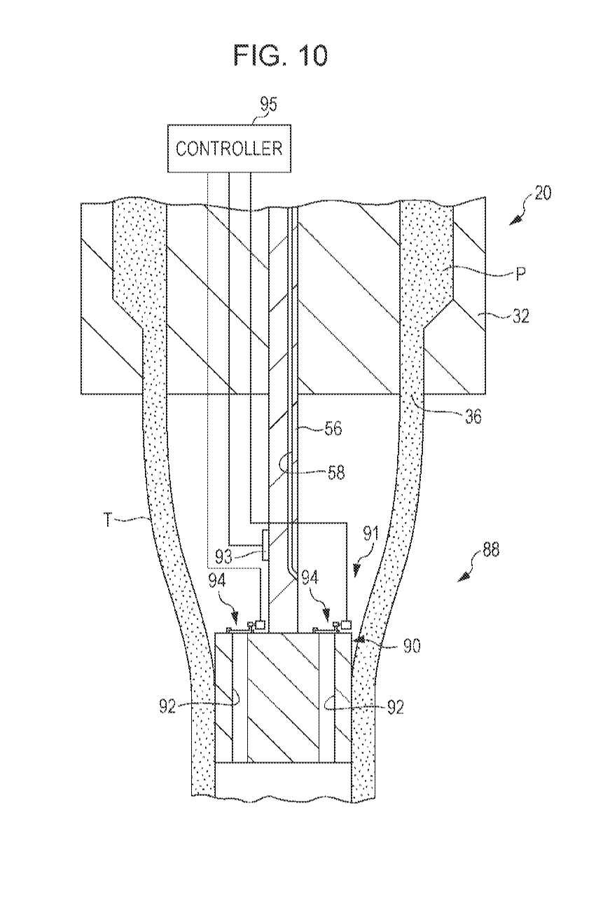

As illustrated in FIGS. 9 and 10, a sizing die 90 of the sizing mechanism 88 according to the fifth exemplary embodiment is formed with two through-holes 92, and is provided with changing devices 94, each of which is an example of a changing unit that changes the flow rate of the air passing through the corresponding through-hole 92. Accordingly, a ventilation mechanism 91, which discharges the air in the cylindrical resin T to the outside, includes the through-holes 92 and the changing devices 94.

Further, the sizing mechanism 88 is provided with a detection sensor 93 and a controller 95. The detection sensor 93 is an example of a detection member which detects the air pressure in the cylindrical resin T transported between the ferrule 20 and the sizing die 90. The controller 95 controls the changing devices 94 on the basis of the result of detection by the detection sensor 93, to thereby change the flow rate of the air passing through the through-holes 92.

Specifically, as illustrated in FIG. 9, each of the changing devices 94 includes a shutter member 96 and a stepping motor 98. The shutter member 96 is movably supported to change an opening area of an upper opening portion of the corresponding through-hole 92, and is formed with a rack gear 96A at an end portion thereof. The stepping motor 98 has an output shaft fixed with a pinion gear 98A meshed with the rack gear 96A. The rotation direction and the rotation angle of the stepping motor 98 are controlled by the above-described controller 95.

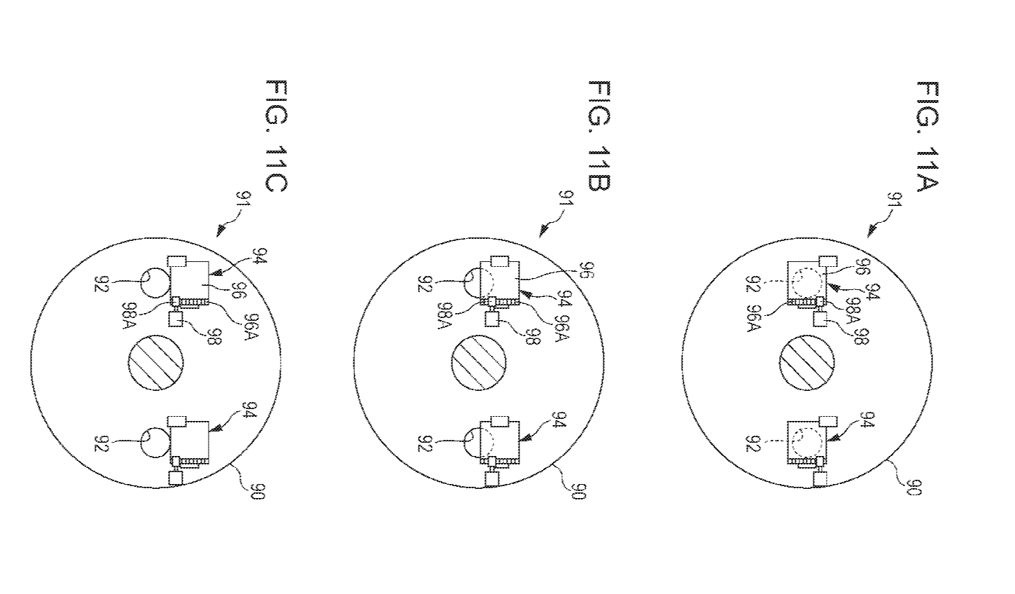

With this configuration, as illustrated in FIGS. 9 and 11A, the detection sensor 93 detects, for example, that the air pressure in the cylindrical resin T transported between the ferrule 20 and the sizing die 90 is equal to the atmospheric pressure. In this case, the controller 95 controls the stepping motors 98 to move the shutter members 96 via the pinion gears 98A and the rack gears 96A and thereby close the respective opening portions of the through-holes 92 (reduce the respective opening areas to 0 mm²).

Further, as illustrated in FIGS. 9 and 11B, the detection sensor 93 detects that the air pressure in the cylindrical resin T transported between the ferrule 20 and the sizing die 90 is higher in value than the atmospheric pressure. In this case, the controller 95 controls the stepping motors 98 to move the shutter members 96 via the pinion gears 98A and the rack gears 96A and thereby open the opening portions of the through-holes 92 and increase the opening areas.

Further, as illustrated in FIGS. 9 and 11C, the detection sensor 93 detects that the air pressure in the cylindrical resin T transported between the ferrule 20 and the sizing die 90 is further higher in value than the atmospheric pressure. In this case, the controller 95 controls the stepping motors 98 to move the shutter members 96 via the pinion gears 98A and the rack gears 96A and thereby open the opening portions of the through-holes 92 and further increase the opening areas.

As described above, if the air pressure in the cylindrical resin T is high, the degree of opening (opening degree) of the opening portions of the through-holes 92 is greater than in a case where the air pressure in the cylindrical resin T is low. Accordingly, the air in the cylindrical resin T is effectively discharged to the outside. The fifth exemplary embodiment is similar to the first exemplary embodiment in the other operations.

Specific exemplary embodiments of the invention have been described in detail. It is, however, apparent to practitioners skilled in the art that the invention is not limited to the exemplary embodiments, and that various other exemplary embodiments are possible within the scope of the invention. For example, the cylindrical resin T is cooled by the use of the fans 62 in the above-described exemplary embodiments. However, the sizing die may be formed with a water pipe and cooled by water running through the water pipe, to thereby cool the cylindrical resin T.

In the above-described exemplary embodiments, description has been made with reference to specific numbers of the members, openings, and so forth. However, the described numbers are examples, and the numbers of the members, openings, and so forth may be more or less than the described numbers.

In the above-described fifth exemplary embodiment, each of the shutter members 96 is moved by the use of the rack gear 96A and the pinion gear 98A. However, the shutter member 96 may be moved by the use of another structure.

In the above-described fifth exemplary embodiment, the two shutter members 96 are moved at the same time. However, only one of the shutter members 96 may be moved.

In the above-described fifth exemplary embodiment, each of the shutter members 96 is configured to be stopped during the movement thereof. However, the shutter member 96 may be configured to be moved only between an open position for opening the through-hole 92 and a close position for closing the through-hole 92.

The foregoing description of the exemplary embodiments of the present invention has been provided for the purposes of illustration and description. It is not intended to be exhaustive or to limit the invention to the precise forms disclosed. Obviously, many modifications and variations will be apparent to practitioners skilled in the art. The embodiments were chosen and described in order to best explain the principles of the invention and its practical applications, thereby enabling others skilled in the art to understand the invention for various embodiments and with the various modifications as are suited to the particular use contemplated. It is intended that the scope of the invention be defined by the following claims and their equivalents.

What is claimed is:

1. A shape adjusting mechanism for an extrusion molding machine, the shape adjusting mechanism comprising:
a shape adjusting member that comes into contact with an inner circumferential surface of a molten substantially cylindrical resin extruded and transported from a ferrule provided to an extrusion molding machine, and adjusts the shape of the substantially cylindrical resin;
a blow-in mechanism that blows a gas into the substantially cylindrical resin transported between the ferrule and the shape adjusting member; and
a discharge mechanism that discharges to the outside the gas in the substantially cylindrical resin transported between the ferrule and the shape adjusting member.

2. The shape adjusting mechanism for an extrusion molding machine according to claim 1, wherein the discharge mechanism corresponds to a ventilation mechanism provided to the shape adjusting member, and the ventilation mechanism includes a through-hole passing through the shape adjusting member in a transport direction of the substantially cylindrical resin.

3. The shape adjusting mechanism for an extrusion

2. The machine according to claim 2, wherein the ventilation mechanism includes a changing unit that changes the flow rate of the gas passing through the through-hole.

4. The shape adjusting mechanism for an extrusion molding machine according to claim 3, wherein the changing unit includes
an opening and closing valve that is movably provided to change the flow rate of the gas passing through the through-hole, and
an elastically deformable member that supports the opening and closing valve, and is elastically deformed by a gas pressure in the substantially cylindrical resin received by the opening and closing valve, to thereby move the opening and closing valve to increase the degree of opening of the through-hole.

5. The shape adjusting mechanism for an extrusion molding machine according to claim 3, further comprising:
a detection member that detects a gas pressure in the substantially cylindrical resin transported between the ferrule and the shape adjusting member; and
a controller that controls the changing unit on the basis of the result of detection by the detection member, to thereby change the flow rate of the gas passing through the through-hole.

6. A method of manufacturing a cylindrical member, the method comprising:
extruding a molten resin material into a substantially cylindrical resin from a ferrule provided to an extrusion molding machine;
adjusting, with the use of the shape adjusting mechanism for an extrusion molding machine according to claim 1, the shape of the extruded substantially cylindrical resin; and
cutting the shape-adjusted substantially cylindrical resin into a determined length, to thereby form a substantially cylindrical member.
